(19) United States
(12) Patent Application Publication
(10) Pub. No.: US 2022/0243064 A1
(43) Pub. Date: Aug. 4, 2022

(54) SILICONE RUBBER COMPOSITION FOR A CURING MEMBRANE COATING

(71) Applicant: COMPAGNIE GENERALE DES ETABLISSEMENTS MICHELIN, Clermont-Ferrand (FR)

(72) Inventors: Milan Fedurco, Clermont-Ferrand (FR); Marco Ribezzo, Clermont-Ferrand (FR); Antonio Delfino, Clermont-Ferrand (FR); Alain Faugeras, Clermont-Ferrand (FR)

(21) Appl. No.: 17/626,338

(22) PCT Filed: Jul. 27, 2020
(86) PCT No.: PCT/FR2020/051380

§ 371 Date: Jan. 11, 2022

(30) Foreign Application Priority Data
Jul. 29, 2019 (FR) FR1908587

(51) Int. Cl. C08L 83/04; C08K 3/36; C08L 77/00; C08G 77/08; C08G 77/12; C08G 77/20; C09D 183/04

(52) U.S. Cl. CPC C08L 83/04; C08K 3/36; C08L 77/00; C08G 77/08; C08K 2201/005; C08G 77/20; C09D 183/04; C08L 2205/02; C08L 2205/03; C08G 77/12

(57) ABSTRACT

A silicone rubber composition is provided. The silicone rubber composition comprises a hydrophobic silica, polyamide microparticles, a liquid organopolysiloxane having two chain ends each bearing an alkenyl group, a liquid polyhydroalkylsiloxane having two chain ends each bearing an SiR′₃O_{1/2} group, and a hydrosilylation catalyst. The ratio of the number of (R′HSiO_{2/2}) units in the polyhydroalkylsiloxane to the number of alkenyl groups is greater than 5. Such a composition has good adhesive properties with respect to a crosslinked butyl rubber composition, good friction resistance properties and good flexibility properties.

### CROSS-REFERENCE TO RELATED APPLICATIONS

This U.S. national phase patent application claims priority to and the benefit of International Patent Application No. PCT/FR2020/051380, filed on Jul. 27, 2020, which claims priority to and the benefit of French patent application no. FR1908587, filed Jul. 29, 2019, the contents of which are incorporated herein by reference in their entirety.

### BACKGROUND

### 1. Technical Field

The field of the present invention is that of silicone rubber compositions intended to be used as an adhesive coating on a curing bladder surface.

### 2. Related Art

Expandable curing bladders for the manufacture of tires are conventionally made of a rubbery material which is generally a crosslinked and reinforced composition of butyl rubber, a copolymer of isobutylene and isoprene. The constituent compositions of the curing bladders conventionally used therefore have a composition very similar to the rubber compositions which constitute the inner liner of the tires and which comes into contact with the surface of the bladder of a curing mold when the tire is cured.

Specifically, tires are usually obtained by molding and vulcanizing a green casing inside a curing mold. The external walls of the casing are flattened against the internal walls of the curing mold by means of a curing bladder which can expand under the effect of a pressurized fluid. The tread pattern on the mold inserts and that on the shells is imprinted onto the green casing, which is vulcanized with the aid of heat.

The curing bladder opens out inside the green casing prior to curing and folds up at the end. For this reason, relative movements occur between the bladder and the casing, which is liable to produce deformations of the casing and wear of the bladder. The degradation of the bladder by these deformation and wear phenomena is also accentuated by two factors. The first factor is the propensity of the surface of the bladder and of the surface of the inner liner of the tire to stick to one another due to the similarity of their chemical composition. The second factor is the severity of the conditions of use of the bladder, since the curing of the tires is carried out at temperatures of at least 100° C. and at pressures of greater than 10 bar in the presence of steam.

To prevent degradation of the bladder, in particular by preventing the adhesion of the inner rubber of the tire to the curing bladder, the inner liner of the green casing of the tires is generally coated with a solution with non-stick properties, for example based on silicone polymers, and known under the name of “lining cement”. Such a treatment is carried out before the curing, by an operator who works on a dedicated station, at the end of the process for assembling the constituent semi-finished products of the tire. This operation proves to consume a great deal of time and manpower.

To overcome this problem, it has been proposed to eliminate this step of applying a lining cement to the surface of the bladder. One solution consists in affixing an adhesive coating to the surface of the bladder. The adhesive coatings generally consist of crosslinked silicone rubber compositions, as is described for example in documents U.S. Pat. No. 4,889,677, US 2008/0093771, WO 2018/115600 and WO 2015/166412. Irrespective of the modifications made to the bladder, the bladder must, after several curing cycles, retain its flexibility in order to be able to inflate and deflate at each curing cycle without the coating becoming detached. Moreover, due to the relative movements between the bladder and the casing which have been mentioned, the coating must also exhibit good friction resistance in order to impart good wear resistance to the bladder.

### SUMMARY

The applicant has discovered that the introduction of polyamide microparticles into a silicone rubber composition leads not only to a good adhesive property with respect to a crosslinked butyl rubber composition, but also to good friction resistance properties while maintaining the required flexibility properties of the curing bladder. Furthermore, the silicone rubber composition has good adhesive properties without it being necessary to pretreat the crosslinked butyl rubber composition via plasma treatment, corona treatment or with an adhesion primer.

Thus, a first subject of the invention is a silicone rubber composition which comprises a hydrophobic silica, polyamide microparticles, a first liquid organopolysiloxane having (R₂SiO_{2/2}) repeating units and having two chain ends each bearing an alkenyl group, a second liquid organopolysiloxane having (R′HSiO_{2/2}) repeating units and having two chain ends each bearing an SiR′₃O_{1/2} group, a hydrosilylation catalyst with Pt(0) complexed with divinyltetraalkylsiloxane ligands, the second organopolysiloxane being a polyhydroalkylsiloxane, the mole ratio of the number of (R′HSiO_{2/2}) units to the number of alkenyl groups being greater than 5, the R symbols, which may be identical or different, representing an alkyl, aryl or aralkyl group, the R′ symbols, which may be identical or different, representing an alkyl group.

A second subject of the invention is a laminate comprising a first layer of a crosslinked diene rubber composition and a second layer of a silicone rubber composition in accordance with the invention, the second layer directly covering the first layer.

The invention also relates to a process for manufacturing a tire which comprises the curing of a green casing of a tire in a curing mold equipped with an expandable curing bladder constituted completely or partly of a laminate in accordance with the invention.

### DETAILED DESCRIPTION

The compounds mentioned in the description can be of fossil origin or be biobased. In the latter case, they may be partially or completely derived from biomass or be obtained from renewable starting materials derived from biomass. Elastomers, plasticizers, fillers and the like are notably concerned.

In the present application, the term “liquid substance” is understood to mean a substance having the ability to eventually assume the shape of its container at room temperature (23° C.).

The essential feature of the silicone rubber composition according to the invention is to comprise a first organopolysiloxane which contains (R₂SiO_{2/2}) units and a second organopolysiloxane which contains (R′HSiO_{2/2}) units and SiR′₃O_{1/2} units, the R symbols representing an alkyl, aryl or aralkyl group, the R′ symbols representing an alkyl group. The groups represented by the symbols R and R′ preferably contain 1 to 8 carbon atoms, more preferentially 1 to 3 carbon atoms.

The first organopolysiloxane has (R₂SiO_{2/2}) repeating units in which the R symbols, which may be identical or different, represent an alkyl, aryl or aralkyl group, preferentially an alkyl group. Within the first organopolysiloxane, the units of formula (R₂SiO_{2/2}) can be differentiated from one another by the nature of R. Preferably, the groups represented by the R symbols in the (R₂SiO_{2/2}) units contain 1 to 8 carbon atoms, more preferentially 1 to 3 carbon atoms. Even more preferably, the R symbols in the (R₂SiO_{2/2}) units represent a methyl. The first organopolysiloxane is preferentially a polydialkylsiloxane, more preferentially a polydimethylsiloxane.

According to the invention, two of the chain ends of the first organopolysiloxane each bear an alkenyl group. An alkenyl group is understood to mean a hydrocarbon-based group which contains a carbon-carbon double bond. Preferably, the alkenyl groups are vinyl groups, of well-known formula —CH═CH₂. Very advantageously, two of the chain ends of the first organopolysiloxane each bear a vinyl group. When the first organopolysiloxane has a linear chain, the first organopolysiloxane is an α,ω-alkenyl, preferably α,ω-vinyl, organopolysiloxane. Preferably, the first organopolysiloxane has a linear chain.

The first organopolysiloxane is a liquid polyorganosiloxane. Preferably, it has a weight-average molecular mass of greater than 5000 g/mol and less than 200 000 g/mol. More preferentially, it has a weight-average molecular mass of greater than 10 000 g/mol and less than 150 000 g/mol.

The first organopolysiloxane may be a product that is commercially available, for example from Wacker, Gelest, Dow Corning, Bluestar, Shin-Etsu, Cabot. It may also be a mixture of several organopolysiloxanes which differ from one another by their repeating units or their macrostructure.

The second organopolysiloxane is a polyhydroalkylsiloxane. The units of formula (R′HSiO_{2/2}) in which the R′ symbol represents an alkyl group are the repeating units of the second organopolysiloxane. In other words, all the monomer units of the second organopolysiloxane are of formula (R′HSiO_{2/2}). Within the second organopolysiloxane, the units of formula (R′HSiO_{2/2}) can be differentiated from one another by the nature of R′. Preferably, the group represented by R′ contains 1 to 8 carbon atoms, more preferentially 1 to 3 carbon atoms. Even more preferentially, the R′ symbols represent a methyl, in which case the second organopolysiloxane is preferentially a polyhydromethylsiloxane.

According to the invention, two of the chain ends of the second organopolysiloxane each bear an SiR′₃O_{1/2} group, the R′ symbols, which may be identical or different, representing an alkyl group. Preferably, the groups represented by the R′ symbols in SiR′₃O_{1/2} contain 1 to 8 carbon atoms, more preferentially 1 to 3 carbon atoms. Even more preferably, the R′ symbols in SiR′₃O_{1/2} represent a methyl. Very advantageously, two of the chain ends of the second organopolysiloxane each bear an SiMe₃O_{1/2} group. When the second organopolysiloxane has a linear chain, the second organopolysiloxane is an α,ω-SiR′₃O_{1/2} polyhydroalkylsiloxane, preferably α,ω-SiMe₃O_{1/2} polyhydroalkylsiloxane. Preferably, the second organopolysiloxane has a linear chain.

Advantageously, the second organopolysiloxane is an α,ω-SiMe₃O_{1/2} polyhydromethylsiloxane.

The second organopolysiloxane is a liquid polyorganosiloxane. Preferably, it has a weight-average molecular mass of greater than 500 g/mol and less than 30 000 g/mol. More preferentially, it has a weight-average molecular mass of greater than 500 g/mol and less than 10 000 g/mol. Even more preferentially, it has a weight-average molecular mass of greater than 1000 g/mol and less than 5000 g/mol.

The second organopolysiloxane may be a product that is commercially available, for example from Wacker, Gelest, Sigma-Aldrich. It may also be a mixture of several organopolysiloxanes which differ from one another by their repeating units or the macrostructure.

Preferably, at least one of the first organopolysiloxane and second organopolysiloxane has a linear chain. Advantageously, both, that is to say the first organopolysiloxane and the second organopolysiloxane, have a linear chain.

The respective amounts of the first organopolysiloxane and of the second organopolysiloxane in the composition according to the invention are governed by the ratio of the number of (R′HSiO_{2/2}) units to the number of alkenyl groups and are adjusted accordingly taking into account the relative proportions of the alkenyl units in the first organopolysiloxane and the relative proportions of the (R′HSiO_{2/2}) units in the second organopolysiloxane.

An essential feature of the silicone rubber composition in accordance with the invention is the ratio of the number of (R′HSiO_{2/2}) units of the second organopolysiloxane introduced into the rubber composition to the number of alkenyl groups of the first organopolysiloxane introduced into the rubber composition. According to the invention, this ratio of the number of (R′HSiO_{2/2}) units to the number of alkenyl groups is greater than 5. A value less than or equal to 5 results in a composition having mechanical and adhesive properties that are insufficient for use as a coating on a diene surface of a substrate subjected to numerous deformation cycles. Advantageously, this ratio is greater than 15, very advantageously greater than 25. Preferably, this ratio is less than 100, preferably less than 90. According to a very preferred embodiment, this ratio is greater than 15 and less than 100. Advantageously, this ratio is greater than 25 and less than 90.

The silicone rubber composition in accordance with the invention also has the feature of containing a hydrosilylation catalyst intended to catalyse the hydrosilylation reaction of the organosiloxanes of the silicone rubber composition by reaction of the (R′HSiO_{2/2}) units of the second organopolysiloxane and alkenyl groups of the first organopolysiloxane. The hydrosilylation catalyst is a catalyst containing Pt(0) platinum complexed with divinyltetraalkylsiloxane ligands, preferably 1,3-divinyltetramethylsiloxane. Such catalysts are for example described in document WO 0142258 A1. Karstedt's catalyst is very particularly suitable. As in any conventional hydrosilylation reaction, the amount of catalyst in the composition is catalytic. A catalytic amount is understood to mean less than one molar equivalent of platinum relative to the amount of olefinic double bond type unsaturations present in the composition. In general, it is sufficient to introduce less than 1000 ppm and preferably more than 30 ppm of platinum calculated relative to the total mass of the first organopolysiloxane and of the second organopolysiloxane.

The reaction of the (R′HSiO_{2/2}) units of the second organopolysiloxane and of the alkenyl groups of the first organopolysiloxane by hydrosilylation results in the crosslinking of the organopolysiloxanes of the silicone rubber composition and makes it possible to produce a crosslinked silicone rubber composition. Crosslinking is typically initiated by bringing the silicone rubber composition to a temperature sufficient to enable the hydrosilylation reaction. It is generally carried out at a temperature between 15° C. and 300° C., for example between 20° C. and 240° C., better still between 70° C. and 200° C.

In a known manner, crosslinkable silicone compositions generally contain an inhibitor. Inhibitors are generally used to regulate the temperature and time of the hydrosilylation crosslinking reaction and thus further control the crosslinking reaction, in particular the initiation thereof and the rate thereof. If a crosslinking inhibitor is used, the amount of inhibitor used is preferentially from 1 to 50 000 ppm, more preferentially from 20 to 2000 ppm, and in particular from 100 to 1000 ppm, relative to the total mass of the first organopolysiloxane and of the second organopolysiloxane. Very particularly suitable as inhibitor are acetylenic alcohols, such as 1-ethynyl-1-cyclohexanol, 2-methyl-3-butyn-2-ol, 3,5-dimethyl-1-hexyn-3-ol, 3-methyl-1-dodecyn-3-ol, 2-phenyl-3-butyn-2-ol. Preferably, the silicone rubber composition according to the invention contains an inhibitor.

The silicone rubber composition according to the invention also has the essential feature of comprising a hydrophobic silica. In a known manner, a hydrophobic silica is a silica, part of the surface of which is covered with organic groups such as alkyl groups. The silica can be any reinforcing silica known to those skilled in the art, in particular any precipitated or fumed silica. Preferably, the silica has a BET specific surface area of less than 450 m²/g, preferentially within a range of from 80 to 400 m²/g, in particular from 100 to 300 m²/g, advantageously from 150 to 250 m²/g. It is also possible to use a mixture of several silicas.

To make the silica hydrophobic, it is well known to modify the surface of the silica. The modification of the surface of a silica can be obtained in a known manner by reacting the silica with compounds which bear hydrophobic groups such as trialkylsilyl groups, in particular trimethylsilyl groups. Very particularly suitable is a silica which has a surface modified by trimethylsilyl groups. Mention may be made, for example, of those obtained by modification with hexamethyldisilazane. According to any one of the embodiments of the invention, the hydrophobic silica preferentially has a carbon content of greater than 2%, more preferentially greater than or equal to 3% by weight relative to the mass of silica.

In the present disclosure, the BET specific surface area is determined by gas adsorption using the Brunauer-Emmett-Teller method described in “The Journal of the American Chemical Society”, (Vol. 60, page 309, February 1938), and more specifically according to a method derived from Standard NF ISO 5794-1, appendix E, of June 2010 [multipoint (5 point) volumetric method—gas: nitrogen—degassing under vacuum: one hour at 160° C. —relative pressure p/po range: 0.05 to 0.17].

The content of hydrophobic silica is adjusted by those skilled in the art depending on its specific surface area and on the use of the silicone rubber composition. Preferably, the content of hydrophobic silica in the silicon rubber composition is greater than or equal to 5% of the total weight of silica, of the first organopolysiloxane and of the second organopolysiloxane and less than or equal to 40% of the total weight of silica, of the first organopolysiloxane and of the second organopolysiloxane. Below 5% of the total weight of silica, of the first organopolysiloxane and of the second organopolysiloxane, the reinforcing properties of the composition may prove to be insufficient for certain applications. Beyond 40% of the total weight of silica, of the first organopolysiloxane and of the second organopolysiloxane, the silicone rubber composition may prove to be too rigid.

The silicone rubber composition further comprises polyamide microparticles. The polyamide microparticles may be products that are available commercially, for example from the company Arkema, such as those sold under the name “Orgasol”. The polyamide microparticles may be of any shape, preferentially they are spherical.

The polyamide microparticles preferably have a melting point above 100° C., preferentially above 150° C. The melting temperature is conventionally measured according to the ASTM D3418-03 standard. As suitable polyamides, mention may be made of nylon 6, nylon 6,6, nylon 6,10, nylon 6,12, nylon 11 and nylon 12. The polyamide microparticles preferably have a particle size of from 5 to 100 μm, advantageously from 10 to 70 μm. The particle size is typically determined according to the ISO 13319-2007 standard.

The incorporation of polyamide microparticles makes it possible to improve the friction resistance properties of the crosslinked rubber composition without the reinforcement and flexibility properties of the crosslinked silicone rubber composition and without its adhesion properties with respect to a surface of a crosslinked diene, in particular butyl, rubber composition being degraded. Indeed, the polyamide microparticles are not torn from the crosslinked silicone rubber composition under the effect of abrasive friction, which reflects the good ability in the cured state of the silicone rubber composition to retain the polyamide microparticles, even under the effect of abrasive friction. This good retention capacity gives it good friction resistance. This good friction resistance is maintained even after several deformation cycles of the crosslinked silicone rubber composition.

The content of polyamide microparticles in the silicone rubber composition is preferentially greater than or equal to 5% of the total weight of polyamide microparticles, of silica, of the first organopolysiloxane and of the second organopolysiloxane and less than or equal to 15% of the total weight of polyamide microparticles, of silica, of the first organopolysiloxane and of the second organopolysiloxane.

The silicone rubber composition in accordance with the invention can be prepared by incorporating the hydrophobic silica into the first organopolysiloxane, followed by the addition of the polyamide microparticles, then the addition of the second polyorganosiloxane with mixing, and finally the addition of the catalyst. When an inhibitor is used, it is typically added to the mixture of hydrophobic silica and the first organopolysiloxane before the incorporation of the second organopolysiloxane. To facilitate mixing, a silicone solvent, preferably decamethylcyclopentasiloxane, is preferably added. The addition of the solvent makes it possible not only to facilitate the incorporation of the constituents of the silicone rubber composition and the homogenization thereof in the silicone rubber composition, but also to adjust the viscosity of the silicone rubber composition with a view to applying it on a substrate.

The silicone rubber composition in accordance with the invention is typically applied on a substrate in the form of a layer, for example using a fine brush, a brush or by spraying. When the rubber composition is applied in the form of a layer on a surface of a substrate, a surface formed of a diene rubber, which is preferentially crosslinked, the silicone rubber composition thus applied to the substrate is crosslinked.

When the silicone rubber composition contains a solvent to facilitate the incorporation and homogenization of its constituents and to adjust its viscosity, all or part of the solvent is removed during the crosslinking of the silicone rubber composition.

The layer of the crosslinked rubber composition preferentially has a thickness ranging from 10 to 500 μm.

According to a particularly preferred embodiment of the invention, the substrate is a diene rubber or a diene rubber composition, the diene rubber preferentially being a butyl rubber.

The invention also relates to a laminate. The laminate according to the invention comprises a first layer of a crosslinked diene rubber composition and a second layer of a silicone rubber composition in accordance with the invention, described according to any one of the embodiments of the invention relating to the silicone rubber composition. In the laminate in accordance with the invention, the second layer directly covers the first layer. The expression “the second layer directly covers the first layer” is understood to mean that the second layer covers the first layer while being in contact therewith. The second layer can directly cover all or part of the second layer. Advantageously, the second layer directly covers the whole of the second layer. Preferentially, the crosslinked diene rubber composition of the first layer comprises a butyl rubber which advantageously represents more than 90%, better still 100% by weight of all the elastomers of the crosslinked diene rubber composition of the first layer.

According to one particular embodiment of the laminate in accordance with the invention, the first layer is formed of a crosslinked diene rubber composition comprising a butyl rubber and forms an expandable curing bladder, in particular intended for tire manufacture. The laminate according to this particular embodiment constitutes all or part of an expandable curing bladder, the second layer having a thickness preferentially ranging from 10 to 500 μm. The laminate exhibits both good reinforcement and flexibility properties for use in an expandable curing bladder, and also good resistance to delamination and good friction resistance.

Expandable curing bladders, in particular intended for the manufacture of tires, are well known to those skilled in the art. They consist of compositions based on halogenated or non-halogenated butyl rubber. Butyl rubber is a copolymer of isobutylene and isoprene known for its airtightness properties. A rubber composition constituting a curing bladder generally contains a reinforcing filler such as a carbon black. It also contains a crosslinking system composed of a resin. Crosslinking systems composed of a resin and used to crosslink rubber compositions for an expandable curing bladder are also well known to those skilled in the art. The resin is typically a halogenated or non-halogenated phenolic resin. As phenolic resin, mention may be made of phenol-formaldehyde resins. The rubber composition constituting a curing bladder may comprise various ingredients such as antioxidants, antiozonants, pigments, waxes, plasticizers such as processing oils.

The application of the silicone rubber composition in accordance with the invention in the form of a layer on a diene rubber composition can be carried out by any means known to those skilled in the art, for example using a brush or by spraying the silicone rubber composition.

In summary, the invention can be implemented according to any one of embodiments 1 to 32:

Embodiment 1: Silicone rubber composition which comprises a hydrophobic silica, polyamide microparticles, a first liquid organopolysiloxane having (R₂SiO_{2/2}) repeating units and having two chain ends each bearing an alkenyl group, a second liquid organopolysiloxane having (R′HSiO_{2/2}) repeating units and having two chain ends each bearing an SiR′₃O_{1/2} group, a hydrosilylation catalyst with Pt(0) complexed with divinyltetraalkylsiloxane ligands,

the second organopolysiloxane being a polyhydroalkylsiloxane, the ratio of the number of (R′HSiO_{2/2}) units to the number of alkenyl groups being greater than 5, the R symbols, which may be identical or different, representing an alkyl, aryl or aralkyl group, the R′ symbols, which may be identical or different, representing an alkyl group.

Embodiment 2: Rubber composition according to embodiment 1, in which the alkenyl groups are vinyl groups.

Embodiment 3: Rubber composition according to either one of embodiments 1 and 2, in which the groups represented by the symbols R and R′ contain from 1 to 8 carbon atoms, preferably 1 to 3 carbon atoms.

Embodiment 4: Rubber composition according to any one of embodiments 1 to 3, in which the R symbols in (R₂SiO_{2/2}) units represent an alkyl.

Embodiment 5: Rubber composition according to any one of embodiments 1 to 4, in which at least one of the first organopolysiloxane and second organopolysiloxane has a linear chain.

Embodiment 6: Rubber composition according to any one of embodiments 1 to 5, in which the first organopolysiloxane and the second organopolysiloxane have a linear chain.

Embodiment 7: Rubber composition according to any one of embodiments 1 to 6, in which the first organopolysiloxane is a polydialkylsiloxane.

Embodiment 8: Rubber composition according to any one of embodiments 1 to 7, in which the first organopolysiloxane is a polydimethylsiloxane.

Embodiment 9: Rubber composition according to any one of embodiments 1 to 8, in which the second organopolysiloxane is a polyhydromethylsiloxane.

Embodiment 10: Silicone rubber composition according to any one of embodiments 1 to 9, in which the first organopolysiloxane has a weight-average molecular mass of greater than 5000 and less than 200 000 g/mol, preferably greater than 10 000 and less than 150 000 g/mol.

Embodiment 11: Silicone rubber composition according to any one of embodiments 1 to 10, in which the second organopolysiloxane has a weight-average molecular mass of greater than 500 and less than 30 000 g/mol, preferably greater than 500 and less than 10 000 g/mol, more preferentially greater than 1000 and less than 5000 g/mol.

Embodiment 12: Silicone rubber composition according to any one of embodiments 1 to 11, in which the R′ symbols in SiR′₃O_{1/2} represent a methyl.

Embodiment 13: Silicone rubber composition according to any one of embodiments 1 to 12, in which the ratio of the number of (R′HSiO_{2/2}) units to the number of alkenyl groups is less than 100.

Embodiment 14: Silicone rubber composition according to any one of embodiments 1 to 13, in which the ratio of the number of (R′HSiO_{2/2}) units to the number of alkenyl groups is less than 90.

Embodiment 15: Silicone rubber composition according to any one of embodiments 1 to 14, in which the ratio of the number of (R′HSiO_{2/2}) units to the number of alkenyl groups is greater than 15, preferentially greater than 25.

Embodiment 16: Silicone rubber composition according to any one of embodiments 1 to 15, in which the ratio of the number of (R′HSiO_{2/2}) units to the number of alkenyl groups is greater than 25 and less than 90.

Embodiment 17: Silicone rubber composition according to any one of embodiments 1 to 16, in which the catalyst is Karstedt's catalyst.

Embodiment 18: Silicone rubber composition according to any one of embodiments 1 to 17, which composition contains an inhibitor.

Embodiment 19: Silicone rubber composition according to any one of embodiments 1 to 18, in which the silica has a BET specific surface area of from 100 to 300 m²/g, preferably from 150 to 250 m²/g.

Embodiment 20: Silicone rubber composition according to any one of embodiments 1 to 19, in which the silica has a surface modified by trimethylsilyl groups.

Embodiment 21: Silicone rubber composition according to any one of embodiments 1 to 20, in which the silica has a surface modified by hexamethyldisilazane.

Embodiment 22: Silicone rubber composition according to any one of embodiments 1 to 21, in which the hydrophobic silica has a carbon content of greater than 2%, preferentially greater than or equal to 3% by weight relative to the mass of silica.

Embodiment 23: Rubber composition according to any one of embodiments 1 to 22, in which the content of hydrophobic silica is greater than or equal to 5% of the total weight of silica, of the first organopolysiloxane and of the second organopolysiloxane and less than or equal to 40% of the total weight of silica, of the first organopolysiloxane and of the second organopolysiloxane.

Embodiment 24: Rubber composition according to any one of embodiments 1 to 23, in which the polyamide microparticles have a melting point above 100° C.

Embodiment 25: Rubber composition according to any one of embodiments 1 to 24, in which the polyamide microparticles have a melting point above 150° C.

Embodiment 26: Rubber composition according to any one of embodiments 1 to 25, in which the polyamide microparticles have a particle size of from 5 to 100 μm.

Embodiment 27: Rubber composition according to any one of embodiments 1 to 26, in which the polyamide microparticles have a particle size of from 10 to 70 μm.

Embodiment 28: Rubber composition according to any one of embodiments 1 to 27, in which the content of polyamide microparticles in the silicone rubber composition is greater than or equal to 5% of the total weight of polyamide microparticles, of silica, of the first organopolysiloxane and of the second organopolysiloxane and less than or equal to 15% of the total weight of polyamide microparticles, of silica, of the first organopolysiloxane and of the second organopolysiloxane.

Embodiment 29: Laminate comprising a first layer of a crosslinked diene rubber composition and a second layer of a silicone rubber composition defined in any one of embodiments 1 to 28, the second layer directly covering the first layer.

Embodiment 30: Laminate according to embodiment 29, in which the crosslinked diene rubber composition of the first layer comprises a butyl rubber.

Embodiment 31: Laminate according to embodiment 30, in which the butyl rubber represents more than 90% by weight of all the elastomers of the crosslinked diene rubber composition of the first layer, better still 100% by weight of all the elastomers of the crosslinked diene rubber composition of the first layer.

Embodiment 32: Laminate according to any one of embodiments 29 to 31, which laminate constitutes all or part of an expandable curing bladder.

The abovementioned characteristics of the present invention, and also others, will be understood more clearly on reading the following description of several implementation examples of the invention, which are given as non-limiting illustrations.

### Examples

II.1 Tests and Measurements:

Elongation Test:

The sample to be tested is obtained using a 10 [mm]×140 [mm] hollow punch. The sample is placed in a vice. Using a gripper and a 300 [mm] ruler, the sample is stretched until 100% deformation is achieved. This deformation is performed 10 times at a frequency of 1 Hz.

Friction Test:

It is carried out on a steel bar with a roughness of around 1.6. Diameter 12 [mm] and length 70 [mm]. The bar is placed vertically in the vice. The sample already tested in elongation is used. The sample is moved back and forth with a curvature of 180 on the treated side (face of the sample coated with the silicone rubber composition) against the bar while exerting a friction force of 5 kilogram-force. 20 cycles are repeated, one cycle corresponding to a back and forth movement at a frequency of between 1 and 2 Hz.

Analysis:

After the elongation test or friction test, the sample is observed by scanning microscopy analysis (FEG 250 model from the company FEI/ThermoFischer, ETD detector (Everhart Thornley detector), 1 kV) to verify the presence or absence of cracks or delamination. The microscopy analysis also makes it possible to estimate the thickness of the layer of the silicone rubber composition applied as a coating.

II.2 Preparation of the Rubber Compositions and Results:

Example 1 in Accordance with the Invention:

A hydrophobic fumed silica (3.8 g, “HDK-2000”, Wacker) is incorporated into an α,ω-vinyl polydimethylsiloxane (7.0 g, “V35”, Gelest, weight-average molecular mass, Mw, 49 500, 2 vinyl units/mol) by mixing for one minute in a mixer (“StateMix”). This resulting mixture, once it has returned to room temperature (23° C.), is suspended in decamethylcyclopentasiloxane (4.0 g, TCI) which contains 7.0 mg of inhibitor (1-ethynyl-1-cyclohexanol) by mixing for one minute in the mixer (“StateMix”). The polyamide microparticles (1.25 g, “Orgasol 2002 D NAT 1”, Arkema) are incorporated into this resulting mixture, once it has returned to room temperature (23° C.), by mixing for one minute in the mixer. Mixing is stopped to allow the mixture to return to room temperature. Poly(methylhydro)siloxane (PHMS) (0.56 g, reference 17,620-6, Sigma Aldrich, Mw 3200 g/mol, 52 (MeHSiO_{2/2}) units) is incorporated into this new mixture by mixing in the mixer (“StateMix”). Mixing is stopped to allow the mixture to return to room temperature. Just before its use, 23.0 μl of Karstedt's catalyst (2% in xylene, Sigma Aldrich) predissolved in 4 g of decamethylcyclopentasiloxane are added thereto. The resulting mixture is homogenized in the mixer (StateMix) for one minute. In the silicone rubber composition, the ratio of the number of (MeHSiO_{2/2}) units to the number of vinyl groups is 32.

The silicone rubber composition thus obtained is applied using a fine brush in the form of a layer on a curing bladder based on butyl rubber. The resulting laminate is brought to 150° C. for 30 minutes in a ventilated air oven.

The 20-40 μm thick crosslinked silicone rubber composition exhibits good adhesion to the bladder and does not detach from the bladder even after having successively undergone 10 elongations at 100% deformation.

Furthermore, it is observed that the polyamide microparticles are not removed from the coating by friction. The polyamide microparticles are not torn from the coating when subjected to the friction test.

Example 2 in Accordance with the Invention:

A hydrophobic fumed silica (5.846 g, HDK-2000, Wacker) is incorporated into an α,ω-vinyl polydimethylsiloxane (10.815 g, DMS V35, Mw 49 500, Gelest) by mixing for one minute in a mixer (“StateMix”). A solution of inhibitor (11 mg, 1-ethynyl-1-cyclohexanol, Aldrich E51406) in decamethylcyclopentasiloxane (10.366 g, TCI Europe, D1890) is then added by mixing for one minute in the mixer (“StateMix”). The polyamide microparticles (1.95 g, “Orgasol ES3 Nat 3”, diameter 30 μm, Arkema) are added and everything is mixed in the mixer for 1 minute (StateMix). A solution of PHMS (0.86 g, poly(methylhydro)siloxane, Mw 3200, reference 17.620-6, Sigma Aldrich) in decamethylcyclopentasiloxane (4.21 g, D, TCI Europe, D1890) is incorporated into the resulting mixture by mixing in the mixer (StateMix, operating at 100% of its power). To finish, a solution of Karstedt's catalyst (36.1 μl, Aldrich 479519) in decamethylcyclopentasiloxane (15.89 g, TCI Europe, D1890) is added. The resulting mixture is homogenized in the mixer (“StateMix”) for 1 minute.

The silicone rubber composition thus obtained is applied using a fine brush in the form of a layer on a curing bladder based on butyl rubber. The resulting laminate is brought to 150° C. for 30 minutes in a ventilated air oven. In the silicone rubber composition, the ratio of the number of (MeHSiO_{2/2}) units to the number of vinyl groups is 32.

The 20-50 μm thick crosslinked silicone rubber composition exhibits good adhesion to the bladder and does not detach from the bladder even after having successively undergone 10 elongations at 100% deformation.

Furthermore, it is observed that the polyamide microparticles are not removed from the coating by friction. The polyamide microparticles are not torn from the coating when subjected to the friction test.

Example 3 in Accordance with the Invention:

Example 3 differs from Example 2 in that α,ω-vinyl polydimethylsiloxane has a weight-average molecular mass of 25 000 g/mol (Sigma-Aldrich, 433012). The ratio of the number of (MeHSiO_{2/2}) units to the number of vinyl groups is 32.

The 5-10 μm thick crosslinked silicone rubber composition exhibits good adhesion to the bladder and does not detach from the bladder even after having successively undergone 10 elongations at 100% deformation.

Example 4 in Accordance with the Invention:

Example 4 differs from Example 2 in that α,ω-vinyl polydimethylsiloxane has a weight-average molecular mass of 117 000 (DMS V46, Gelest). The ratio of the number of (MeHSiO_{2/2}) units to the number of vinyl groups is 32.

The 5-10 μm thick crosslinked silicone rubber composition exhibits good adhesion to the bladder and does not detach from the bladder even after having successively undergone 10 elongations at 100% elongation.

Example 5 in Accordance with the Invention:

Example 5 differs from Example 2 in that the poly(methylhydro)siloxane has a weight-average molecular mass of 950 g/mol (Aldrich, 482196). The ratio of the number of (MeHSiO_{2/2}) units to the number of vinyl groups is 32.

The 5-10 μm thick crosslinked silicone rubber composition exhibits good adhesion to the bladder and does not detach from the bladder even after having successively undergone 10 elongations at 100% elongation.

Example 6 not in Accordance with the Invention:

Step 1:

From an adhesion primer (“G791A”, Wacker), the volatile hydrocarbon-based solvents are removed by evaporation under vacuum at 40° C. Next, 5 g of the adhesion primer thus treated are suspended in 30.3 g of decamethylcyclopentasiloxane (TCI). These are mixed for one hour with stirring with a magnetic bar at 23° C., then 7.26 mg of 1-ethynyl-1-cyclohexanol dissolved in 2.0 g of decamethylcyclopentasiloxane (TCI) are added. Next, mixing is carried out for one minute at 23° C. Then α,ω-vinyl polydimethylsiloxane (5.0 g, “V35”, Gelest) is added. Next, mixing is carried out still with stirring with a magnetic bar for 15 minutes at room temperature (23° C.). Next, 22.4 μl of Karstedt's catalyst (2% in xylene, Sigma Aldrich) predissolved in 2.0 g of decamethylcyclopentasiloxane are added. Next, mixing is carried out for 5 minutes at room temperature.

The adhesion primer composition thus obtained is applied using a fine brush in the form of a layer on a curing bladder based on butyl rubber. The resulting laminate is brought to 150° C. for 30 minutes in a ventilated air oven.

The 20-40 μm thick crosslinked silicone rubber composition exhibits good adhesion to the bladder and does not detach from the bladder even after having successively undergone 10 elongations at 100% deformation.

Step 2:

The “Vario 15” (6.54 g, Wacker) and “Vario 40” (1.64 g, Wacker) silicones are mixed in a mixer (“StateMix” operating at 100% of its power) for one minute. Then after adding an inhibitor (5.6 mg, 1-ethynyl-1-cyclohexanol) dissolved in 2.5 g of decamethylcyclopentasiloxane (TCI), they are mixed for one minute. Next, the polyamide microparticles (1 g, “Orgasol 2002 D NAT 1”, diameter 20 μm, Arkema) are added and mixed for 1 minute, then allowed to cool to room temperature (23° C.). Next the “Vario KAT” catalyst (0.82 g, Wacker) is added, mixed for 1 minute, then allowed to cool to room temperature. Next, 17.2 μl of Karstedt's catalyst (2% in xylene, Sigma Aldrich) predissolved in 2.2 g of decamethylcyclopentasiloxane are added. Mixing is carried out for one minute.

The silicone rubber composition thus obtained is applied in the form of a layer on the curing bladder obtained in step 1, i.e. covered with the adhesion primer composition obtained in step 1. The laminate thus obtained is brought to 150° C. for 30 minutes in a ventilated air oven.

The 20-30 μm thick crosslinked silicone rubber composition exhibits good adhesion to the bladder and does not detach from the bladder even after having successively undergone 10 elongations at 100% deformation. However, it is observed that the polyamide microparticles are removed from the coating by friction.

Example 7 in Accordance with the Invention:

A hydrophobic fumed silica (5.8 g, “HDK-2000”, Wacker) is incorporated into an α,ω-vinyl polydimethylsiloxane (9.7 g, “V35” with a weight-average molecular mass of 49 500, Gelest) by mixing for one minute in a mixer (“StateMix”). This resulting mixture, once it has returned to room temperature (23° C.), is suspended in decamethylcyclopentasiloxane (10.8 g, TCI) which contains 11.4 mg of inhibitor (1-ethynyl-1-cyclohexanol) by mixing for one minute in the mixer (“StateMix”). The polyamide microparticles (1.96 g, “Orgasol 2002 D NAT 1”, Arkema) are incorporated into this resulting mixture, once it has returned to room temperature (23° C.), by mixing for one minute in the mixer. Mixing is stopped to allow the mixture to return to room temperature. Poly(methylhydro)siloxane (PHMS) (1.93 g, reference 17,620-6, Sigma Aldrich) in solution in decamethylcyclopentasiloxane (7.2 g, TCI) is incorporated into this new mixture by mixing in the mixer (“StateMix”). Mixing is stopped to allow the mixture to return to room temperature. Just before its use, 37.6 μl of Karstedt's catalyst (2% in xylene, Sigma Aldrich) predissolved in 12.4 g of decamethylcyclopentasiloxane are added thereto. The resulting mixture is homogenized in the mixer (StateMix) for one minute. In the silicone rubber composition, the ratio of the number of (MeHSiO_{2/2}) units to the number of vinyl groups is 80.

The silicone rubber composition thus obtained is applied using a fine brush in the form of a layer on a curing bladder based on butyl rubber. The resulting laminate is brought to 150° C. for 30 minutes in a ventilated air oven.

The 20-40 μm thick crosslinked silicone rubber composition exhibits good adhesion to the bladder and does not detach from the bladder even after having successively undergone 10 elongations at 100% deformation.

Furthermore, it is observed that the polyamide microparticles are not removed from the coating by friction. The polyamide microparticles are not torn from the coating when subjected to the friction test.

Example 8 not in Accordance with the Invention:

A hydrophobic fumed silica (5.45 g, “HDK-2000”, Wacker) is incorporated into an α,ω-vinyl polydimethylsiloxane (10.81 g, “V35” with a weight-average molecular mass of 49 500, Gelest) by mixing for one minute in a mixer (“StateMix”). This resulting mixture, once it has returned to room temperature (23° C.), is suspended in decamethylcyclopentasiloxane (12 g, TCI) which contains 10.3 mg of inhibitor (1-ethynyl-1-cyclohexanol) by mixing for one minute in the mixer (“StateMix”). The polyamide microparticles (1.82 g, “Orgasol 2002 D NAT 1”, Arkema) are incorporated into this resulting mixture, once it has returned to room temperature (23° C.), by mixing for one minute in the mixer. Mixing is stopped to allow the mixture to return to room temperature. Poly(methylhydro)siloxane (PHMS) (0.108 g, reference 17,620-6, Sigma Aldrich) in solution in decamethylcyclopentasiloxane (3.1 g, TCI) is incorporated into this new mixture by mixing in the mixer (“StateMix”). Mixing is stopped to allow the mixture to return to room temperature. Just before its use, 33.8 μl of Karstedt's catalyst (2% in xylene, Sigma Aldrich) predissolved in 13.2 g of decamethylcyclopentasiloxane are added thereto. The resulting mixture is homogenized in the mixer (StateMix) for one minute. In the silicone rubber composition, the ratio of the number of (MeHSiO_{2/2}) units to the number of vinyl groups is 4.

The silicone rubber composition thus obtained is applied using a fine brush in the form of a layer on a curing bladder based on butyl rubber. The resulting laminate is brought to 150° C. for 30 minutes in a ventilated air oven.

The 20-40 μm thick crosslinked silicone rubber composition exhibits poor adhesion to the bladder and detaches from the bladder.

In the cured state, the silicone rubber compositions of Examples 1 to 5 and 7, all in accordance with the invention, exhibit good adhesion to the bladder: they do not detach from the bladder even after having successively undergone 10 elongations at 100% deformation.

Furthermore, the polyamide microparticles are not torn from the crosslinked silicone rubber compositions during the friction test, which reflects the good ability in the cured state of the silicone rubber compositions to retain the polyamide microparticles, even under the effect of abrasive friction. This good retention capacity gives them good friction resistance. This good friction resistance is maintained even after several deformation cycles of the crosslinked silicone rubber composition.

On the other hand, the crosslinked silicone rubber compositions of Examples 6 and 8 which are not in accordance with the invention do not exhibit such good properties. In fact, the polyamide microparticles are removed from the crosslinked silicone rubber composition during the friction test. Since the polyamide microparticles are torn from the crosslinked silicone rubber composition, its friction resistance is greatly reduced.

1. A silicone rubber composition which comprises a hydrophobic silica, polyamide microparticles, a first liquid organopolysiloxane having (R₂SiO_{2/2}) repeating units and having two chain ends each bearing an alkenyl group, a second liquid organopolysiloxane having (R′HSiO_{2/2}) repeating units and having two chain ends each bearing an SiR′₃O_{1/2} group, a hydrosilylation catalyst with Pt(0) complexed with divinyltetraalkylsiloxane ligands,
the second organopolysiloxane being a polyhydroalkylsiloxane,
the ratio of the number of (R′HSiO_{2/2}) units to the number of alkenyl groups being greater than 5,
the R symbols, which may be identical or different, representing an alkyl, aryl or aralkyl group, the R′ symbols, which may be identical or different, representing an alkyl group.

2. The silicone rubber composition according to claim 1, in which the alkenyl groups are vinyl groups.

3. The silicone rubber composition according to claim 1, in which at least one of the first organopolysiloxane and second organopolysiloxane has a linear chain.

4. The silicone rubber composition according to claim 1, in which the first organopolysiloxane is a polydialkylsiloxane.

5. The silicone rubber composition according to claim 1, in which the second organopolysiloxane is a polyhydromethylsiloxane.

6. The silicone rubber composition according to claim 1, in which the R′ symbols in SiR′₃O_{1/2} represent a methyl.

7. The silicone rubber composition according to claim 1, in which the content of hydrophobic silica is greater than or equal to 5% of the total weight of silica, of the first organopolysiloxane and of the second organopolysiloxane and less than or equal to 40% of the total weight of silica, of the first organopolysiloxane and of the second organopolysiloxane.

8. The silicone rubber composition according to claim 1, in which the ratio of the number of (R′HSiO_{2/2}) units to the number of alkenyl groups is greater than 15.

9. The silicone rubber composition according to claim 1, in which the ratio of the number of (R′HSiO_{2/2}) units to the number of alkenyl groups is greater than 25.

10. The silicone rubber composition according to claim 1, in which the polyamide microparticles have a melting point above 100° C.

11. The silicone rubber composition according to claim 1, in which the polyamide microparticles have a particle size of from 5 to 100 μm.

12. The silicone rubber composition according to claim 1, in which the content of polyamide microparticles in the silicone rubber composition is greater than or equal to 5% of the total weight of polyamide microparticles, of silica, of the first organopolysiloxane and of the second organopolysiloxane and less than or equal to 15% of the total weight of polyamide microparticles, of silica, of the first organopolysiloxane and of the second organopolysiloxane.

13. A laminate comprising a first layer of a crosslinked diene rubber composition and a second layer of a silicone rubber composition defined in claim 1, the second layer directly covering the first layer.

14. The laminate according to claim 13, in which the laminate constitutes all or part of an expandable curing bladder.

15. A process for manufacturing a tire which comprises the curing of a green casing of a tire in a curing mold equipped with an expandable curing bladder constituted completely or partly of a laminate according to claim 13.

16. The silicone rubber composition according to claim 3, in which both the first organopolysiloxane and second organopolysiloxane have a linear chain.

17. The silicone rubber composition according to claim 4, in which the first organopolysiloxane is a polydimethylsiloxane.

18. The silicone rubber composition according to claim 10, in which the polyamide microparticles have a melting point above 150° C.

19. The silicone rubber composition according to claim 11, in which the polyamide microparticles have a particle size of from 10 to 70 μm.

20. The silicone rubber composition according to claim 13, in which the crosslinked diene rubber composition of the first layer comprises a butyl rubber.
